(19) United States
(12) Patent Application Publication
(10) Pub. No.: US 2025/0138137 A1
(43) Pub. Date: May 1, 2025

(54) SYSTEM AND METHOD FOR TRACKING WORK TOOLS

(71) Applicant: DUROBYTE INC., Oldcastle (CA)

(72) Inventor: Alexander James GARNIER, Windsor (CA)

(21) Appl. No.: 18/933,725

(22) Filed: Oct. 31, 2024

Related U.S. Application Data
(60) Provisional application No. 63/595,204, filed on Nov. 1, 2023.

(51) Int. Cl. G01S 5/16

(52) U.S. Cl. CPC G01S 5/16

(57) ABSTRACT

A device and method are proposed that are directed to utilizing 3D tracking approaches and tracker hardware to determine the position and orientation of work tools in 3D space. This position is then validated against a trained position to provide real time feedback on an assembly process. A “work tool” can, for example, be a hand-held tool that is used to perform work, but is not necessarily a hand-held tool. Example work tools include impact drills, torque wrenches, hand-held tooling, or even a human hand.

### CROSS-REFERENCE

This application claims priority from U.S. provisional patent application 63/595,204, titled “SYSTEM AND METHOD FOR TRACKING WORK TOOLS”, filed on Nov. 1, 2023, the contents of which are incorporated herein by reference.

### FIELD

Embodiments of the present disclosure generally relate to the field of advanced manufacturing, and more specifically, embodiments relate to devices, systems and methods for tracking work tools.

### INTRODUCTION

Work tools are commonly used to manufacture products on an assembly line using physical work. Tracking work tools helps ensure that work tools are being used accurately and completed correctly in sequence and position. This is valuable to the quality assurance of the finished product.

However, the tracking tools and systems have technical limitations in respect of tracking positional accuracy, especially in view of challenges in estimating absolute position based on a number of relative position measurements.

Accordingly, improved approaches are desirable to improve the viability of practical tracking solutions by providing more accurate work tool tracking systems.

### SUMMARY

A device and method are proposed that are directed to utilizing 3D tracking approaches and tracker hardware to determine the position and orientation of work tools in 3D space. This position is then validated against a trained position to provide real time feedback on an assembly process. A “work tool” can, for example, be a hand-held tool that is used to perform work, but is not necessarily a hand-held tool. Example work tools include impact drills, torque wrenches, hand-held tooling, or even a human hand.

The device is useful for addressing practical technical challenges that arise during quality assurance of a finished product, for example, validating that work was completed in a correct sequence and/or a correct position. Virtual Reality (VR) tracking approaches, in particular, are used to determine positions (e.g., 3D positions) of the tools performing the work.

In an embodiment, a system for computer-assisted verification of assembly processes is proposed that comprises a work tool coupled with a positional tracker device calibrated with a base station for positioning the positional tracker device in three-dimensional space, including a tool-center-point of the work tool and one or more computer processors configured to account for tracking errors in the positioning of the positional tracker device in three-dimensional space.

A challenge with VR tracking systems is that they have tracking inaccuracies, and as described herein, an approach to account for these errors is proposed. A VR base station can provide a determination of a 3D position (e.g., using a projected beam) that can be relative to a coordinate frame of the base station. A calibrated device, a “tracker” device, is used to locate a position based on a projected beam timing, and thus a position of the tracker can be established.

The tracker device is mounted to a work tool such that geo-spatial features of the work tool can be established relative to the tracker. A work tool can also have one or more tool-center-point where a focus of work being done by the work tool can be tracked (e.g., the point of the tool that “does” the work).

The work tool is being used in respect of a work object, such as a physical object being worked on by the work tool. The work object is essentially a target for the work tool, and the work tool is used for repeatable work as part of a manufacturing process, such as an assembly line, etc., where the work tool has to be used to conduct some steps, for example, manipulating the work object.

As described above, there are tracking errors in VR tracking systems. A proposed approach is to account for these errors the recorded positional data of the tracker is fit to a sphere using a proposed random sample consensus (RANSAC) approach. A RANSAC approach is used to classify the recorded positions as inliers and outliers and produce a best estimated fit for the sphere.

The approach follows the following logic, assuming N positions have been recorded of the trackers position and N>=4.

1. Randomly select exactly 4 recorded tracker positions

2. Find the sphere defined by the 4 positions as a potential fit for the data.

3. Iterate through the remaining N positions and measure how many positions are within a specified distance of the surface of a sphere. Positions that exceed the distance are considered outliers and positions inside the tolerance are inliers.

4. Compare the total number of inliers for this potential fit with previous potential fits.

5. Repeat from step 1 for a configurable number of iterations, or until the ratio of inliers to total positions exceeds a specified value.

6. Use the potential fit with the most inliers as the best potential fit.

The result of the RANSAC approach will be a data object that includes one or more data fields representing the position of a sphere in the 3D coordinate frame (x, y, z position). To convert this position into an offset from the tracker, the inlier positions are iterated. For each recorded position the offset to the center of the sphere is measured. The offsets are then averaged to calculate the tracker to tool-center-point relationship. Ultimately, once the tool-center-point is accurately tracked a user can use the tool to train a model for the work performed on the work object.

The outputs from the tracking can be used, for example, to conduct validations on work object/work tool relationships, for example, and additional training can be used to account for positional inconsistencies in the work object positioning, etc. Additional variations and embodiments are also proposed to account for these positional errors.

This device and method can be practically implemented in the form of a hardware computer system that operates in a manufacturing line or assembly line, having a base station, and trackers interfacing with tooling and work objects or work areas. The device and method can also include firmware or software controllers that control base stations and trackers, such as control circuits having machine-instructions embedded therein for performing steps of proposed methods described herein.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is a perspective diagram of the functional tracking and validation system that includes the core components of the tracking system including the base stations, trackers, works objects, and work tools, according to some embodiments.

FIG. 2 is a diagram of the relationship of the tracker position on the work tool and tool-center-point that is placed on repeatable locations, according to some embodiments.

FIG. 3 is an illustration of performing the work tool at the same location under left handed and right handed orientations, according to some embodiments.

FIG. 4 is a diagram of the horizontal and vertical motion for the tool-center-point calibration procedure, according to some embodiments.

FIG. 5 is an illustration of recorded positions during the tool-center-point calibration process, according to some embodiments.

FIG. 6 is a diagram of validation regions shown on the work object for a functional tracking and validation system, according to some embodiments.

FIG. 7 is an illustration of work object positional errors and work object tracking, according to some embodiments.

### DETAILED DESCRIPTION

A device and method are proposed that are directed to utilizing 3D tracking approaches and tracker hardware to determine the position and orientation of work tools in 3D space. This position is then validated against a trained position to, for example, provide real or near-real time feedback on an assembly process. The assembly process can include work done on an assembly line, or other types of repetitive work where process consistency and accuracy are very important. Examples of this type of work can include automotive manufacturing, food processing, electronics assembly, etc., where the user uses a work tool to conduct tasks such as riveting, screwing, fastening, mounting, opening, etc. A “work tool” can, for example, be a hand-held tool that is used to perform work, but is not necessarily a hand-held tool. Example work tools include impact drills, torque wrenches, hand-held tooling, or even a human hand. The work tool has geo-spatial positioning associated with it, and these can be compared those of the work surface or work object, either relative or absolute positioning, such that usage of the work tool can be validated in respect of an identified work pattern.

The proposed system and corresponding tracker devices are useful for addressing practical technical challenges that arise during quality assurance of a finished product, for example, validating that work was completed in a correct sequence and/or a correct position. Virtual Reality (VR) tracking approaches, in particular, are first used to determine positions (e.g., 3D positions) of the tools performing the work.

The present approach seeks to fulfill a need in assembly processes where physical work is required to assemble a part. Validating that the work is completed in the correct sequence and at the correct position(s) is valuable to the quality assurance of the finished product. The present approach proposes a software solution to tracking the 3D position and location of work performed in real time and validating it against a preconfigured model of the part.

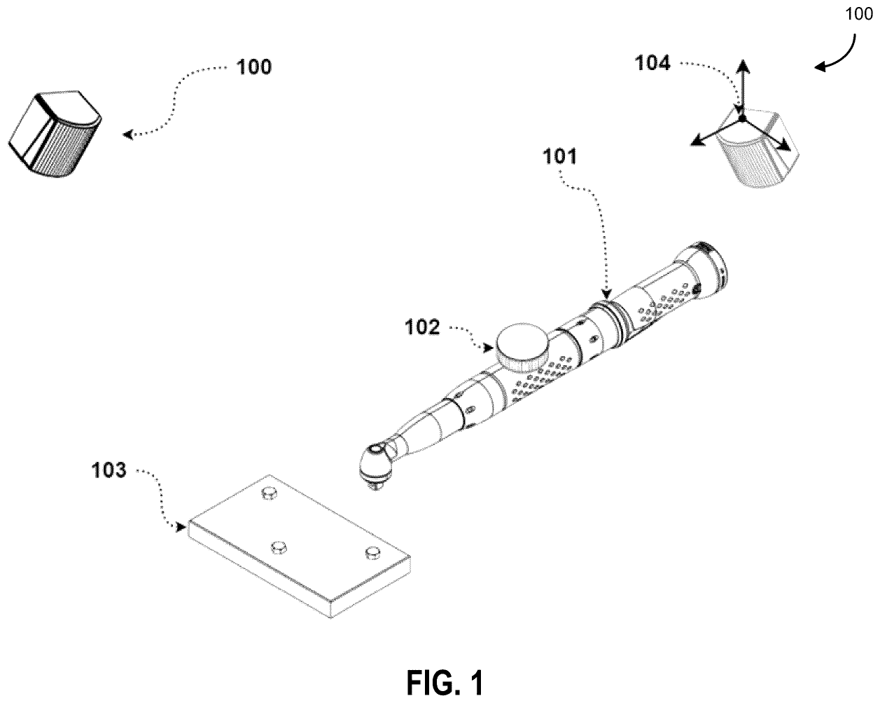

The approach utilizes VR tracking technology to determine the 3D position of the tools performing the work. The illustration in FIG. 1 identifies example components of the tracking system. The example components are shown to illustrate the principle of operation and other, different, or less components are possible. In FIG. 1, two hardware components are depicted, base stations 100 and trackers 102. A base station 100 is a hardware device utilized in VR applications that projects a laser beam at a specific frequency and timing.

The projected laser beam is the mechanism used by the rest of the VR hardware to determine its 3D position. The 3D position can be measured with 6 dimensions, the three positional coordinates along with 3 angular coordinates. The position reported is relative to a 3D coordinate frame defined by the physical location of the base stations 104. A tracker 102 is a calibrated device that locates its position in 3D space from the laser timing sent by the base station. The six-dimensional absolute position of the tracker 102 is reported relative to one of the base stations.

The tracker 102 is physically mounted to the work tool 101 in a repeatable position so that the work tool 101 and tracker 102 form 102 a cohesive rigid body system. In this configuration, any point of the work tool 101 is a fixed offset relative to the position of the tracker 102. A work tool 101 is any hand-held tool that is used to perform work. The illustrated example 101 details a hand-held torque gun; a device used to tighten fasteners and bolts in an assembly process. Other use cases could define the work tool 101 as an impact drill, torque wrench, human hand, or custom built hand-held tooling to aid in an assembly process. The illustrations and descriptions in the present approach are not intended to be an exhaustive list of its possible applications; or to limit the approach to specific use cases. They are intended to cover a generic use case of the system to aid in its functional description.

The final component is the object or part the tool will work on as work object 103. A work object 103 is the physical object that work is being performed on, such as a part being assembled in a manufacturing process. Each work object 103 is not unique and will have some repeatable process that the user must follow to ensure it's built correctly. The areas on the work object 103 where the work tool 101 is used are assumed to be fixed relative to other work areas, such that the work object is a rigid body. A work object 103 will arrive at a workstation via some mechanism, conveyor, automated guided vehicle, or manually loaded by the user. The user will then perform some predefined process on the work object 103 using one or more work tools 101 before releasing the part from the workstation.

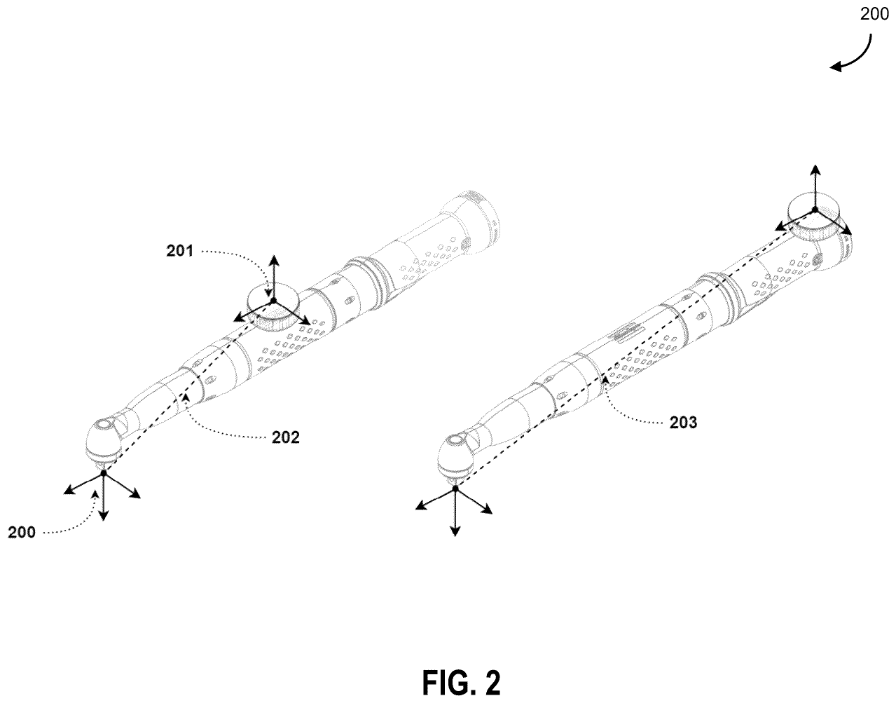

The illustration in FIG. 2 depicts that each work tool 101 has a singular position relative to itself where the work is performed, referred to in the present approach as a tool-center-point 200. For a torque gun, the position would be the socket on the end of the work tool 101, for an impact drill this position would be the end of the installed bit. For an assembly operation this position is defined as the point on the tool that is placed in repeatable locations on the part. Tracking this position on a work tool 101 is essential for validation of the work performed on the part since the orientation of the tool during the process can change.

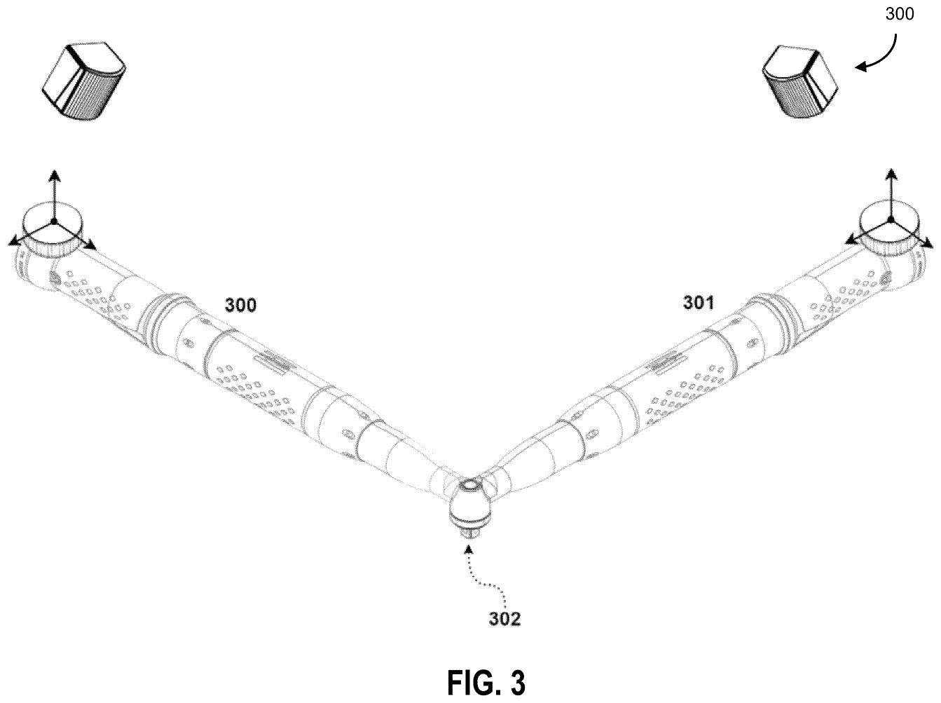

FIG. 3 illustrates this challenge, describing the work tool 101 held in left-hand 300 and right-hand 301 orientations while the tool-center-point 200 is at the same position 302. As illustrated in FIG. 2, it is not feasible to mount the tracker 201 exactly at the tool-center-point 200 so the relationship between the position of the tracker 201 and the tool-center-point 200 needs to be extracted from the system. The transformation between the two positions 202, 203 will vary depending on the position the tracker is mounted to the work tool 101.

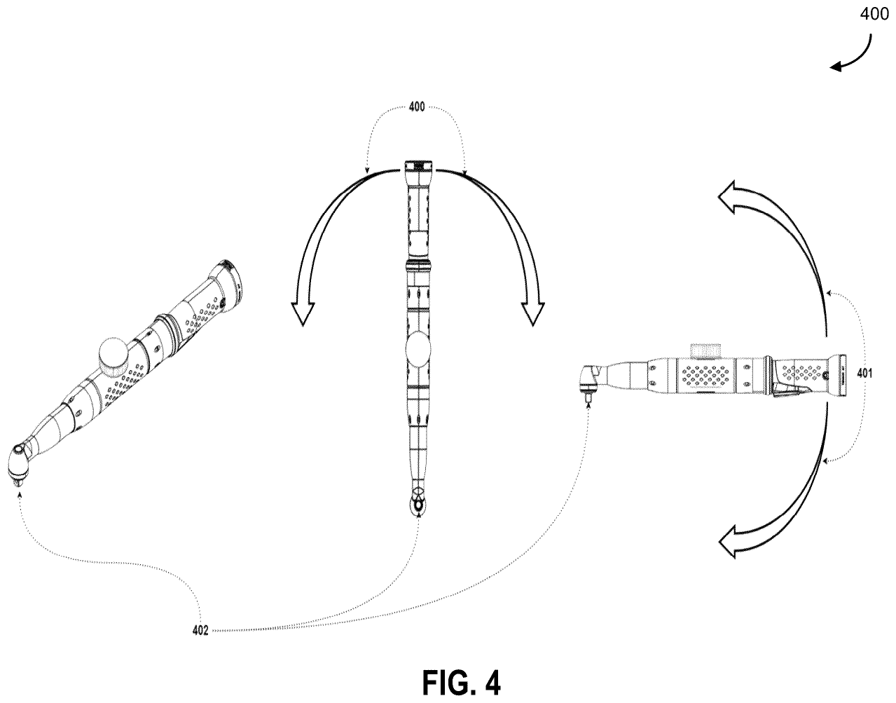

FIG. 4 demonstrates that the present approach provides a mechanism to calculate the tracker to tool-center-point 200 transform by observing the position of the tracker 102 in the 3D coordinate frame. The procedure requires the user to rotate the tool about the desired tool-center-point 402, by keeping the tool-center-point 200 at a fixed position within the 3D coordinate frame. The rotation motion is required to be done in at least two directions that are normal to each other. The motion is illustrated as vertical 401 and horizontal 400 about the desired tool-center-point. The positions of the tracker 102 are recorded hundreds of times per second while the tool 101 is in motion.

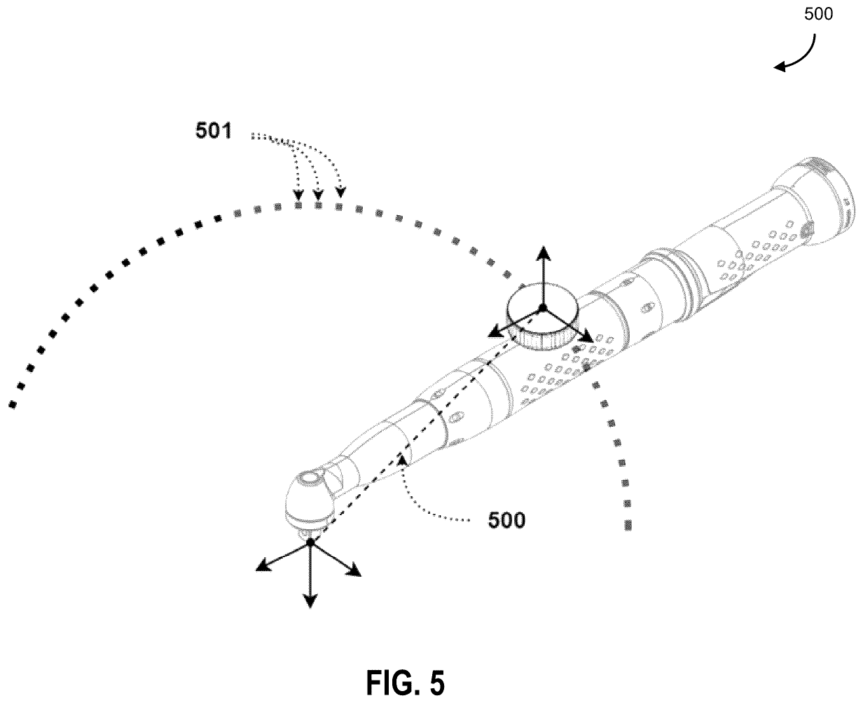

FIG. 5 illustrates that if the tool-center-point 200 is in a fixed position during the rotation and the tracker is rigidly mounted at a fixed distance 500 from the tool-center-point, the recorded positions of the tracker 501 will fit the surface of a sphere.

The recorded position data is prone to some errors due to the tracking accuracy of the VR system, and the ability of the user to keep the tool-center-point 200 precisely fixed within the 3D coordinate frame while rotating the tool 101. To account for these errors the recorded positional data of the tracker 102 is fit to a sphere using a random sample consensus (RANSAC) approach. A RANSAC approach will classify the recorded positions as inliers and outliers and produce a best estimated fit for the sphere.

The approach can follow the following logic, assuming N positions have been recorded of the trackers position and N>=4.

1. Randomly select exactly 4 recorded tracker positions

2. Find the sphere defined by the 4 positions as a potential fit for the data.

3. Iterate through the remaining N positions and measure how many positions are within a specified distance of the surface of a sphere. Positions that exceed the distance are considered outliers and positions inside the tolerance are inliers.

4. Compare the total number of inliers for this potential fit with previous potential fits.

5. Repeat from step 1 for a configurable number of iterations, or until the ratio of inliers to total positions exceeds a specified value.

6. Use the potential fit with the most inliers as the best potential fit.

The result of the RANSAC algorithm will be the position of a sphere in the 3D coordinate frame (x, y, z position). To convert this position into an offset from the tracker the inlier positions are iterated through a final time. For each recorded position the offset to the center of the sphere is measured. The offsets are then averaged to calculate the tracker to tool-center-point relationship.

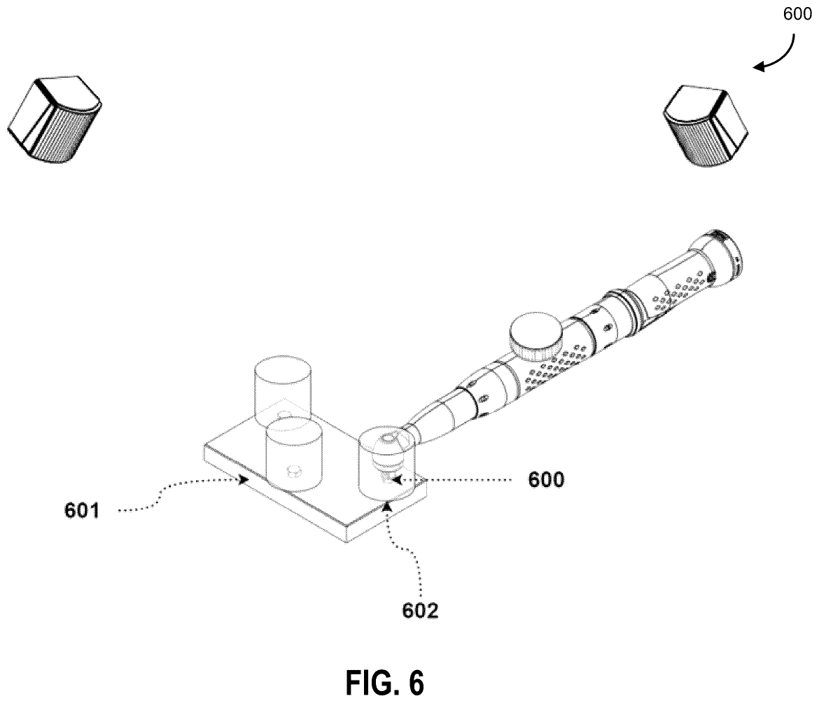

FIG. 6 depicts that once the tool-center-point 600 is accurately tracked a user can use the tool to train a model for the work performed on the work object 601. The user will place the tool-center-point 600 of the tool at the position the work is performed and record the position in the software system. A 3D region is created 602 that surrounds the trained point that defines the boundary of the work area. The user can adjust the size of the 3D region to account for positional errors in the tracking system, or errors that are introduced due to inaccuracies in the repeatability of the position of the work object when it enters the work cell. The region's volume defines a single verification area, such that while the tool-center-point 600 is within the bounds of a region the work required at that position can be validated. In the event of an overlap between two adjacent regions, the region nearest to the current position of the tool-center-point 600 is the reported position of the work tool 101.

Once the work positions are trained into the software system, validation can take place on subsequent work objects that enter the work cell. When the tool-center-point enters a trained 3D region 602 the software system will report the activity to an external control system such as a programmable logic controller (PLC). The external system can combine the validation of the position of the work tool 101 with other validation mechanisms to determine if the work was performed correctly. For example, a torque gun running down a fastener would report its own validation that a torque was completed along with detailed data about the final torque and angle of the bolt. When the torque is completed the PLC would validate this data with the positional data of the work tool 101 provided from the software system to confirm the correct bolt was fastened. Alternatively, the torque gun could be disabled by the PLC until the correct 3D volume is entered by the work tool 101, enforcing a specific sequence to the rundown process.

If the work object is not repeatedly in the same position between operations, any defined 3D regions will have some inaccuracy in their position relative to the work object.

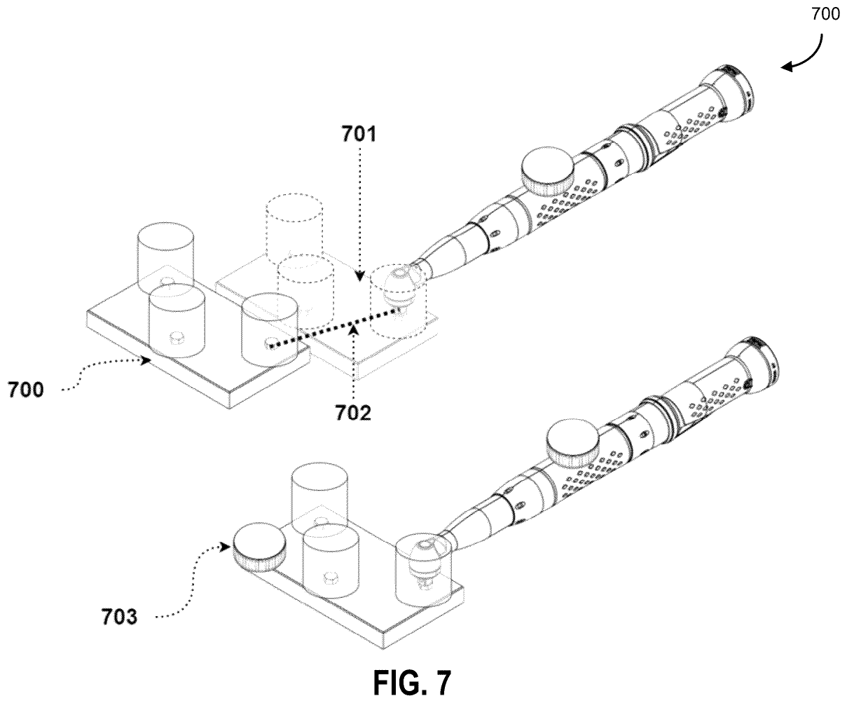

This is due to the 3D coordinate frame being fixed to the environment and not actively tracking the work object's position. If the work object's position in the environment is repeatable enough, errors in its position can be accounted for by adjusting the bounds of the 3D region's that define work areas. In some cases the work object may not be repeatable enough to account for the error by adjusting the region size. This issue is illustrated in FIG. 7, where the trained position of the work object 700 is not the same as the position of the current work object 701.

This results in a position error 702 between the trained position and the current position of the work object. In these instances, the work object can also be tracked in the 3D coordinate system using a tracker 703. The work objects model would be adjusted in the 3D coordinate system based on the reported position of the tracker, adjusting the trained 3D regions accordingly.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

What is claimed is:

1. A system for computer-assisted verification of assembly processes, the system comprising:
a work tool coupled with a positional tracker device calibrated with a base station for positioning the positional tracker device in three-dimensional space, including a tool-center-point of the work tool; and
one or more computer processors configured to account for tracking errors in the positioning of the positional tracker device in three-dimensional space by using a random sample consensus approach.

2. The system of claim 1, wherein the random sample consensus approach includes steps of:
randomly select at least four positions of a plurality of recorded positional tracker device positions;
determine a virtual sphere defined by the at least four positions as a potential fit;
iterate through a remaining N positions of the plurality of recorded positional tracker device positions and determine how many positions are within a specified distance of a surface of the virtual sphere, denoting positions that exceed the specified distance as outliers and positions inside the specified distance as inliers;
compare a total number of inliers for the potential fit with one or more previous potential fits;
repeat the above steps for a configurable number of iterations, or until a ratio of inliers to total positions exceeds a specified value;
generate an output data set corresponding to a best potential fit based at least on the above iterations.

3. The system of claim 1, wherein a preconfigured model is maintained by the system for comparison against a dataset comprising of positions of the tool-center-point over a duration of time.

4. The system of claim 3, wherein the position of the positional tracker device and the position of the tool-center-point is tracked over a period of time to observe the position of the positional tracker device in a three-dimensional coordinate frame.

5. The system of claim 4, wherein to observe the position of the positional tracker device in the three-dimensional coordinate frame, the work tool is rotated by a user about the tool-center-point in at least two dimensions that are normal to one another.

6. The system of claim 5, wherein the rotation of the work tool by the user about the tool-center-point allows positions of the positional tracker device to fit a surface of a sphere, and the random sample consensus approach is utilized to reduce fitting errors to the surface of the sphere by identifying a best fit data structure from a plurality of candidate potential fit data structures.

7. The system of claim 6, wherein once the-tool-center-point is accurately tracked, the preconfigured model can be trained for work performed on the work object.

8. The system of claim 7, wherein movement of the work tool when operating the work object within a verification area, is verified against a reference model to generate one or more score data values corresponding to the movement of the work tool compared to the reference model.

9. The system of claim 8, wherein the one or more score data values include at least one of an angle, a position, and an order in which work is to be completed.

10. The system of claim 8, wherein if a score data value of the one or more score data values deviates from a target score data value by a threshold data value, the work tool is disabled from operation.

11. A method for computer-assisted verification of assembly processes, the method comprising:
coupling a work tool a positional tracker device calibrated with a base station for positioning the positional tracker device in three-dimensional space, including a tool-center-point of the work tool; and
accounting for tracking errors in the positioning of the positional tracker device in three-dimensional space by using a random sample consensus approach.

12. The method of claim 11, wherein the random sample consensus approach includes steps of:
randomly selecting at least four positions of a plurality of recorded positional tracker device positions;
determining a virtual sphere defined by the at least four positions as a potential fit;
iterating through a remaining N positions of the plurality of recorded positional tracker device positions and determine how many positions are within a specified distance of a surface of the virtual sphere, denoting positions that exceed the specified distance as outliers and positions inside the specified distance as inliers;
comparing a total number of inliers for the potential fit with one or more previous potential fits;
repeating the above steps for a configurable number of iterations, or until a ratio of inliers to total positions exceeds a specified value;
generating an output data set corresponding to a best potential fit based at least on the above iterations.

13. The method of claim 11, wherein a preconfigured model is maintained by the method for comparison against a dataset comprising of positions of the tool-center-point over a duration of time.

14. The method of claim 13, wherein the position of the positional tracker device and the position of the tool-center-point is tracked over a period of time to observe the position of the positional tracker device in a three-dimensional coordinate frame.

15. The method of claim 14, wherein to observe the position of the positional tracker device in the three-dimensional coordinate frame, the work tool is rotated by a user about the tool-center-point in at least two dimensions that are normal to one another.

16. The method of claim 15, wherein the rotation of the work tool by the user about the tool-center-point allows positions of the positional tracker device to fit a surface of a sphere, and the random sample consensus approach is utilized to reduce fitting errors to the surface of the sphere by identifying a best fit data structure from a plurality of candidate potential fit data structures.

17. The method of claim 16, wherein once the-tool-center-point is accurately tracked, the preconfigured model can be trained for work performed on the work object.

18. The method of claim 17, wherein movement of the work tool when operating the work object within a verification area, is verified against a reference model to generate one or more score data values corresponding to the movement of the work tool compared to the reference model.

19. The method of claim 18, wherein the one or more score data values include at least one of an angle, a position, and an order in which work is to be completed.

20. The method of claim 18, wherein if a score data value of the one or more score data values deviates from a target score data value by a threshold data value, the work tool is disabled from operation.

21. A computer program product or a non-transitory computer readable medium, storing machine interpretable instructions, which when executed by a processor, cause the processor to perform a method according to claim 11.
